(19) United States
(12) Patent Application Publication
(10) Pub. No.: US 2025/0376357 A1
(43) Pub. Date: Dec. 11, 2025

(54) Device and method for monitoring freight to be loaded

(71) Applicant: SICK AG, Waldkirch (DE)

(72) Inventors: Wahid NASIMZADA, Waldkirch (DE); Jörg SPIEGELHALTER, Waldkirch (DE); Christoph Matthias WIEGAND, Waldkirch (DE); Jan KIFMANN, Waldkirch (DE); Hauke LUDWIG, Waldkirch (DE); Jisheng ZHANG, Waldkirch (DE)

(21) Appl. No.: 19/229,184

(22) Filed: Jun. 5, 2025

(30) Foreign Application Priority Data
Jun. 6, 2024 (EP) 24180464.0

(51) Int. Cl. B66C 13/16; G01B 11/00; G01S 17/89

(52) U.S. Cl. CPC B66C 13/16; G01B 11/002; G01S 17/89

(57) ABSTRACT

A device for monitoring freight to be loaded has at least one sensor that is configured to detect at least one set of spatial coordinates of measurement points, wherein the measurement points lie in a spatial zone that comprises the freight. An evaluation unit is configured to determine at least a part of a contour of the freight from the set of spatial coordinates of the measurement points and to carry out a comparison between the determined contour of the freight and at least one predefined contour. An output unit is configured to output a signal based on a result of the comparison.

The invention relates to a device and to a method for monitoring freight to be loaded, in particular one or more containers, respectively.

The handling of containers plays a central role in the loading of freight in ports. An STS (ship to shore) crane or RTG (rubber tired gantry) crane is typically used to move a container, i.e. to take it up, to transport it, and to place it down again, is typically used to move a container. The STS crane or RTG crane has a crab comprising a spreader to which twistlocks are attached. The twistlocks are provided to engage into and to be fastened to corner castings of the container. Once the spreader has been fastened to the freight container by means of the twistlocks, said container can be raised by means of the crab of the STG crane or RTG crane and can be transported to a desired position at which the container is set down again

The most widespread containers have a length of 20 feet (6.058 m) or 40 feet (12.192 m), with the spreader of a crane as a rule being able to take up a 40 foot container or two 20 foot containers arranged behind one another. From the cab, however, the operator of the crane can frequently not distinguish whether the container beneath the spreader is a 40 foot container or two 20 foot containers. The danger is that the crane operator makes an erroneous decision due to poor/limited visibility or negligence and only secures the respective outer corner castings of the two containers by twistlocks using the spreader and the inwardly disposed corner castings are not locked. The containers can tilt or, in the worst case, come crashing down during the subsequent lifting process. A complex and so expensive recovery is the consequence. This precarious lifting procedure also contains a great risk for humans and machines.

Systems are known from the prior art that can recognize the presence of a gap between two containers to be gripped after the placing of the spreader onto the containers to be gripped. The upper and lateral surfaces of the containers to be gripped are inspected by means of photoelectronic sensors in this position. If a gap is detected by means of the sensors, the recognition of two 20 foot containers is reported to the crane operator or to an automated crane system. A 40 foot container is otherwise reported. It is disadvantageous in this process that the recognition of the containers is only possible in the target position of the spreader and then only when the spreader has been positioned almost centrally. As soon as the spreader is located on the containers displaced by a few centimeters orthogonally to the container gap, the sensors that should detect the gap are no longer between the containers. The detection is thereby made more difficult or is not possible and incorrectly reports a 40 foot container as detected instead of two 20 foot containers.

It is therefore the object of the invention to improve a device and a method for monitoring freight to be loaded, in particular one or more containers.

The object is achieved by a device and by a method for monitoring freight to be loaded, in particular one or more containers, in accordance with the respective independent claim.

A device in accordance with the invention for monitoring freight to be loaded, in particular one or more containers, first comprises at least one sensor, an evaluation unit, and an output unit. The sensor is configured to detect at least one set of spatial coordinates of measurement points. The measurement points lie in a spatial zone that comprises the freight. The evaluation unit is configured to determine at least a part of the contour of the freight from the set of spatial coordinates of the measurement points and to carry out a comparison between the determined contour of the freight and at least one predefined contour. The output unit is configured to output a signal based on a result of the comparison.

The invention has the advantage that a property of interest of the freight can be checked simply and reliably during a loading procedure. It is in particular not necessary to detect the whole contour of the freight, but only the part of a contour that is to be compared with the predefined contour that can likewise preferably only comprise a part of the contour of the freight to be loaded, for example a longitudinal section or cross-section. Both the data acquisition and the data analysis are thereby considerably simplified. This allows an increase in the total operative efficiency of freight terminals and in particular of container terminals thanks to increased security in the handling of the freight or containers and an increase in the throughput in the dynamic and complex environment of container transfer.

The predetermined contour can preferably be a part of a contour of an upper side, in particular a length, of a piece of freight, for example of a container. The upper side of a piece of freight is as a rule easy to detect in particular when the sensor is arranged above the freight, for example at a crane for loading the freight. The term contour is to be interpreted broadly in the sense of the present invention and not only comprises the exact contour of a piece of freight, for example the typical, corrected surface structure of a freight container, but, for example, also a length or width of an upper side of a piece of freight.

A first predefined contour can preferably comprise a part of an upper side of a single container and/or a second predefined contour can comprise a part of an upper side of two containers arranged behind one another. A property of the freight can be determined in a simple manner by the comparison of the determined contour of the freight with the predefined contour or contours and information on the freight can be output, which facilitates the further handling of the freight during loading. The contour of the upper side of a single container thus differs, for example, from the contour of the upper side of two containers arranged behind one another in that there is a gap between the two containers arranged behind one another. Whether the sensor has detected a single container or two containers arranged behind one another can thus be distinguished in a simple manner.

A first predefined contour can preferably comprise a part of an upper side of a 40 foot container, and/or a second predefined contour can comprise a part of an upper side of a 20 foot container, and/or a third predefined contour can comprise a part of an upper side of two 20 foot containers arranged behind one another. The length and the number of the containers to be loaded can thus be determined in a simple manner by the comparison of the determined contour of the freight with the predefined contour or contours. The contour of the upper side of a 40 foot container thus differs, for example, from the contour of the upper side of two 20 foot containers arranged behind one another with substantially the same length in that there is a gap between the two 20 foot containers. The contour and thus the spatial location of the measurement points detected by the sensor thus differ considerably from the spatial location of the measurement points that are detected at a comparable position of a 40 foot container. Whether the sensor has detected a 20 foot container. a 40 foot container or two 20 foot containers arranged behind one another can thus be distinguished in a simple manner.

The sensor can be configured as a LIDAR sensor with which a predetermined spatial zone can be scanned that is predefined by the field of view of the LiDAR sensor. The sensor can therefore be configured for distance measurement, for example by a measurement of the time of flight of light pulses transmitted by the sensor. The spatial location of e.g. a measurement point of the surface of the container can by determined as spatial coordinates by every distance measurement.

In an embodiment of the invention, the sensor can be configured as a 2D LiDAR sensor, with a light beam generated by a laser periodically scanning a predetermined spatial zone with the aid of a deflection unit. The light is remitted at objects in the spatial zone (e.g. the surface of a container) and is evaluated in the scanner. A conclusion is drawn on the angular location of the angular position of the object and from the time of flight additionally on the distance of the object from the laser scanner while using the speed of light. The location of an object in the spatial zone is detected in two-dimensional polar coordinates using the angular data and the distance data. The positions of objects can thus be determined or their contour can be determined. A determination of a contour of the freight along a line Is possible with a 2D LiDAR sensor, which is already sufficient for a plurality of applications such as the above-described distinguishing of a 40 foot container from two 20 foot containers arranged behind one another. A distance between two containers can in particular also be determined. This information is necessary, for example, for a correct positioning on the loading of containers onto a truck trailer.

In alternative embodiment of the invention, the sensor can be configured as a 3D LIDAR sensor, with a relative movement in the transverse direction likewise being detected, for example by a further degree of freedom of movement of the deflection unit in the laser scanner. A contour of the freight along a plurality of lines spatially spaced apart from one another can thus be determined. This allows a redundant evaluation and thus more exact results in the determination of the contour of the freight. A 3D LiDAR sensor can furthermore be configured to fully detect an upper side of the freight. With freight comprising two containers, a lateral displacement of the containers from one another, that is a displacement perpendicular to the longitudinal axis of the containers, can thus also be detected.

The sensor can preferably be attached to a spreader of a crane that is provided to take up the freight. The sensor can then detect a contour of the upper side of the freight when letting the spreader down onto the freight. Typical LiDAR sensors can detect a field of view of more than 180 degrees so that, as a rule, the total surface of the freight up to the placement of the spreader on the freight can be detected. The signal output by the output unit can comprise information for adjusting the spreader. If the freight comprises, for example, one or more containers, the information can comprise the number and size of the containers or can be an indication of the twistlocks to be activated at the spreader to fasten the container or containers securely to the spreader. The information can furthermore comprise a positioning of the spreader relative to the freight.

The output unit can preferably be configured to output the signal to an operator of the crane, for example via corresponding display elements or via voice output. The operator is then able to adjust the spreader correctly to the corresponding freight based on the displayed information. Alternatively or additionally, the output unit can be configured to output the signal to a control of the crane, for example, in the case of an automated crane, with an output of the information to an operator additionally being able to take place to monitor the automated crane.

In accordance with a further embodiment, the evaluation unit can be configured to determine a distance of the freight from the spreader from the set of spatial coordinates of the measurement points and the output unit can be configured to output the determined distance to an operator and/or to a control of the crane. The freight can thereby be efficiently traveled to by the spreader; the approach speed of the spreader can, for example, be adapted to the distance from the freight.

In accordance with a further embodiment, the evaluation unit can be configured to determine an in particular longitudinal offset of the freight from the spreader from the set of spatial coordinates of the measurement points and the output unit can be configured to output the offset to an operator and/or to a control of the crane. The position of the spreader relative to the freight can thereby be adapted during the approach to the freight.

In accordance with a further embodiment, the evaluation unit can be configured to use “prior knowledge” with respect to the freight, for example relative to a predefined spatial zone of the freight or its spatial location during the determination of the contour of the freight. Such “prior knowledge” can reduce the data volume that is to be processed by the evaluation unit. The technical computer effort required to operate the device can thereby be reduced. The processing speed can furthermore be increased.

In accordance with a further embodiment, the evaluation unit can be configured to determine an angle between the upper side of the freight and a lifting direction in which the freight is raised by the crane from the set of spatial coordinates of the measurement points and the output unit can be configured to output the determined angle to an operator and/or to a control of the crane. Whether the freight has been correctly fastened to the spreader can thereby be checked during the raising of the freight. If, for example, the twistlocks of the spreader were erroneously not locked at one end of a container, the crane would only raise the container at one end so that the angle between the upper side of the container and the lifting direction would vary during the lifting procedure. The evaluation unit would detect this angle change. The lifting procedure can be prematurely stopped by the output of information on the angle change to the operator or to the crane control when, for example, the angle change exceeds a predefined value and thus damage to the freight or to the crane is avoided.

The evaluation unit can be a component of the sensor or can be part of an external control unit that can, for example, also comprise the output unit. The predefined contour or the predefined contours of the freight can preferably be stored in a storage unit of the evaluation unit.

The sensor can then have an inertial measurement unit (IMU), with the evaluation unit being able to be configured to receive data of the IMU and to determine a movement of the sensor, in particular relative to the typically stationary freight.

With knowledge of the sensor movement, a plurality of sets of spatial coordinates detected by the sensor can be summed and the robustness of the contour determination can thus be improved.

The sensor can therefore be designed as a so-called solid state LiDAR without any mechanically moving components for the beam deflection. Such a sensor is particularly robust and can have a higher service life than a conventional LiDAR sensor having a rotating scanning unit, in particular in a rough working environment.

A further object of the invention is a method of monitoring freight to be loaded, in particular one or more containers. In accordance with the method, at least one set of spatial coordinates of the measurement points is detected by means of a sensor. The measurement points lie in a spatial zone that comprises the freight. At least a part of the contour of the freight is determined from the set of spatial coordinates of the measurement points, for example by segmenting and clustering the measurement points detected by the sensor. A comparison between the contour of the freight determined and at least one predefined contour of the freight is subsequently carried out and a signal based on a result of the comparison is output.

The above-described device is consequently configured to carry out the steps of the method by means of the sensor, the evaluation unit, and the output unit. The above embodiments of the device in accordance with the invention thus also apply to the method in accordance with the invention, in particular with respect to the disclosure, the advantages, and the preferred embodiments.

The invention will be explained in more detail in the following also with respect to further features and advantages by way of example with reference to embodiments and to the enclosed drawing. The Figures of the drawing show in:

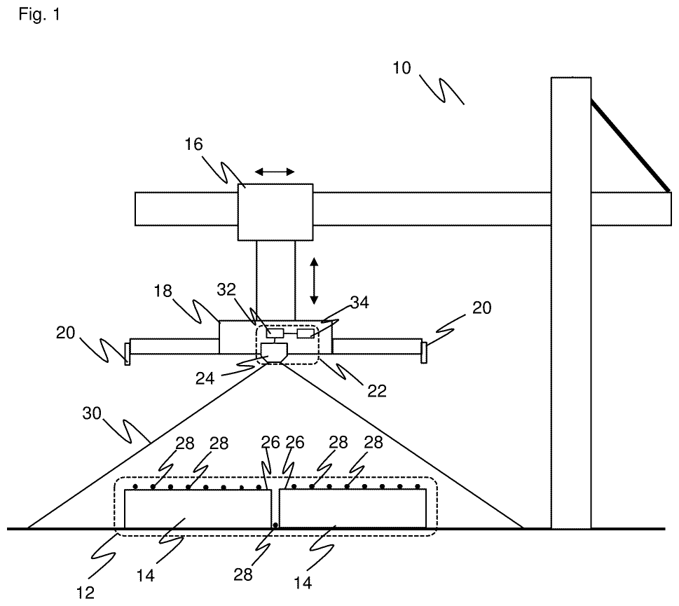

FIG. 1 a schematic representation of a crane having a device in accordance with the invention for monitoring freight to be loaded;

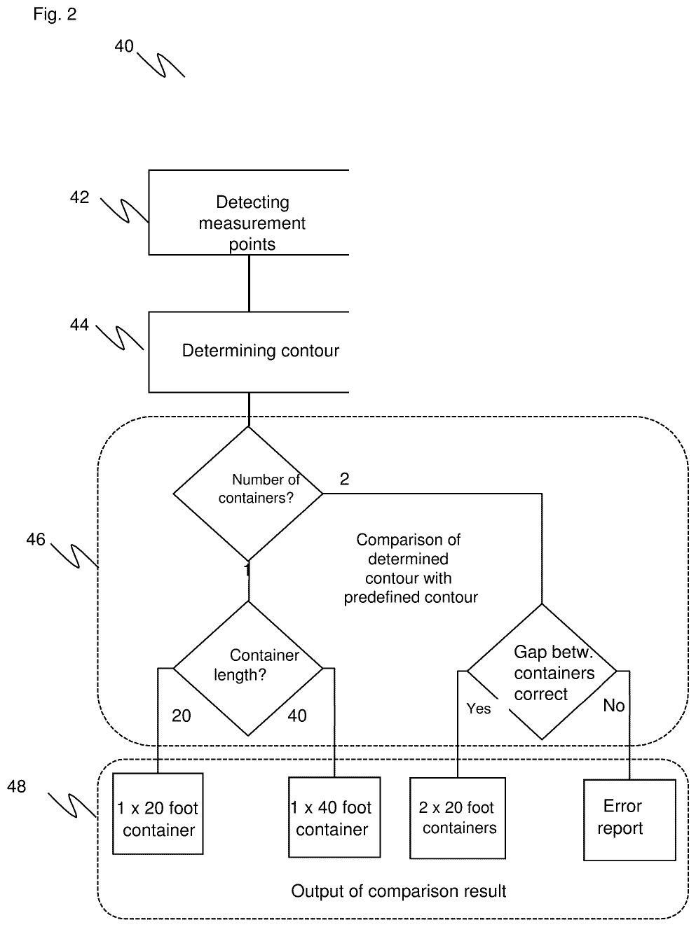

FIG. 2 an exemplary flowchart of a method in accordance with the invention for monitoring freight to be loaded; and

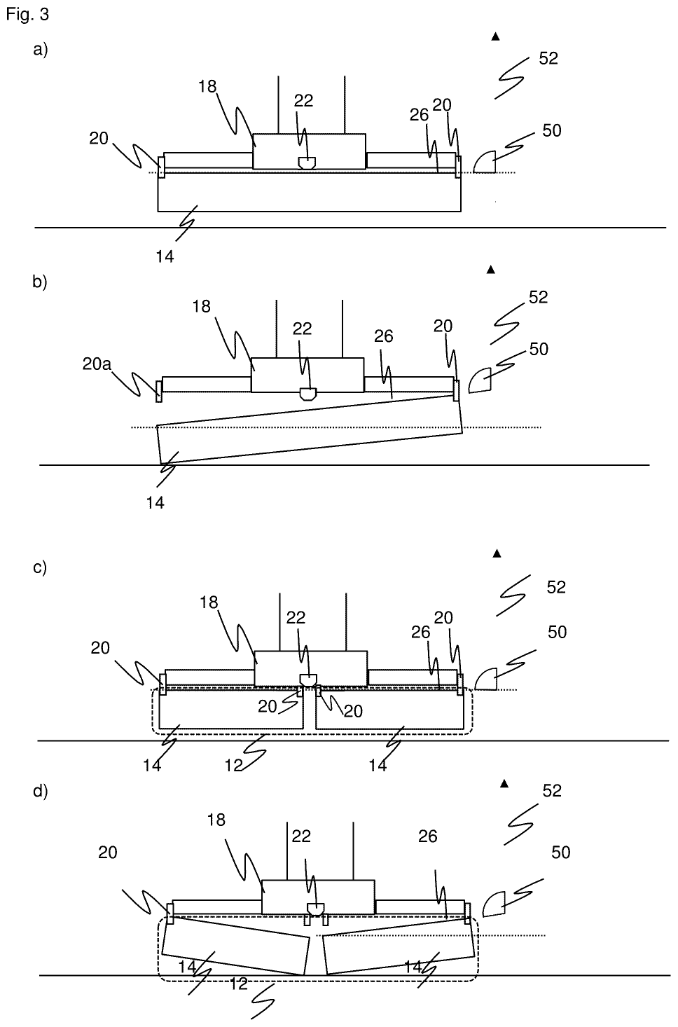

FIG. 3 a schematic representation of an embodiment in which the device in accordance with the invention is configured to determined at least one angle between the upper side of the freight and a lifting direction.

FIG. 1 shows a schematic representation of a crane 10 that is provided to load freight 12, for example containers 14. The crane 10 comprises for this purpose a crab 16 to which a spreader 18 having so-called twistlocks 20 is attached to raise, move, and place down the freight. The crane 10 is, for example, an STS (ship to shore) crane or an RTG (rubber tired gantry) crane such as are typically used in modern port facilities.

A device 22 in accordance with the invention is fastened to the spreader 18 and has a sensor 24 that is configured as a LIDAR sensor. The sensor 24 therefore has a laser scanner that detects a certain spatial zone at the upper side 26 of the containers 14. The sensor 24 is furthermore configured to detect a set of spatial coordinates of measurement points 28 from the field of vision 30 of the sensor 24, i.e. at the upper side 26 of the containers 14.

The sensor 24 is connected to an evaluation unit 32. The connection can take place in a wired or wireless manner. The evaluation unit 32 is configured to determine at least a part of a contour of the freight 12 from the set of spatial coordinates of the measurement points 28 and to carry out a comparison between the determined contour of the freight and at least one predefined contour of the freight 12.

An output unit 34 is configured to output a signal based on a result of the comparison, for example to an operator and/or to a control of the crane (not shown).

FIG. 2 shows an exemplary flowchart 40 of a method in accordance with 40 the invention of monitoring freight 12 to be loaded.

In a first step, a detection 42 takes place by means of a sensor 24 of at least one set of spatial coordinates of measurement points 28 that lie in a spatial zone that comprises freight.

In a subsequent second step, a determination 44 takes place of at least a part of a contour of the freight 12 from the spatial coordinates of measurement points 28, for example using segmentation methods and clustering methods known from image processing.

In a third step, comparison 46 takes place of the determined contour of the freight 12 with at least one predefined contour of the freight 12, for example a check whether the determined contour corresponds to the predefined contour of one or two containers or whether a length of a container corresponds to the length of a 20 foot container or the length of a 40 foot container.

In a further, fourth step, an output 48 then takes place of a signal that is output based on a result of the comparison, for example the information whether the freight is a 20 foot container, a 40 foot container, or two 20 foot containers, An operator or a control of the crane can carry out a setting of the spreader based on the information.

FIG. 3 shows a schematic representation of an embodiment in which the evaluation unit of the device 22 in accordance with the invention is configured to determine at least one angle 50 between the upper side 26 of the freight, in this case one or more containers 14, and a lifting direction 52 in which the freight is raised by the crane.

In a), the container 14 is fastened to the twistlocks 20 of the spreader 18 to be raised in the lifting direction 52. The angle 50 between the upper side 26 of the container 14 and the lifting direction 50 is 90 degrees here, with a certain tolerance; the upper side 26 of the container 14 and the lifting direction 50 therefore form a substantially right angle 50.

In b), a situation is shown by way of example in which the container 14 is not fastened to the spreader at one side since inter alia a twistlock 20a has not been correctly locked. The container 14 is thereby only raised on one side so that the angle 50 between the lifting direction 52 and the upper side 26 of the container 14 changes on the raising of the container. The evaluation unit of the device can detect this change of angle and the lifting procedure can be prematurely stopped and damage to the freight or to the crane can be avoided by an output to an operator of the crane or to a crane control.

In c), two containers 14 are fastened to the twistlocks 20 of the spreader 18 to be raised in the lifting direction 52. The angle 50 between the upper side 26 of the containers 14 and the lifting direction 52 is therefore 90 degrees here, with a certain tolerance; the upper side 26 of the container 14 and the lifting direction 50 therefore form a substantially right angle 50.

In d), a situation is shown by way of example in which the containers 14 are each fastened at the center of the spreader 18, not to the spreader 18. The containers 14 are thereby respectively only raised on one side and the angle 50 between the lifting direction 52 and the upper side 26 of the respective container 14 changes on the raising of the containers 14. The evaluation unit of the device 22 can detect this change of angle and the lifting procedure can be prematurely stopped and damage to the freight or to the crane can be avoided by an output to an operator of the crane or to a crane control. In addition in this case, the contour detected by the device 22 of the surface of the freight 12 formed from the two containers 14 in this case also changes. A corresponding error image can be stored in the evaluation unit, as a predefined contour, for example. If a corresponding contour is detected by the evaluation unit, an error signal can be output.

### REFERENCE NUMERAL LIST

10 crane
12 freight
14 container
16 crab
18 spreader
20, 20a twistlock
22 device
24 sensor
26 upper side
28 measurement point
30 field of vision
32 evaluation unit
34 output unit
40 flowchart
42 detection
44 determination
46 comparison
48 output
50 angle
52 lifting direction

1. A device for monitoring freight to be loaded, the device comprising:
at least one sensor that is configured to detect at least one set of spatial coordinates of measurement points, wherein the measurement points lie in a spatial zone that comprises the freight;
an evaluation unit that is configured to:
determine at least a part of a contour of the freight from the set of spatial coordinates of the measurement points and to carry out a comparison between the determined contour of the freight and at least one predefined contour; and
an output unit that is configured to output a signal based on a result of the comparison.

2. The device in accordance with claim 1, wherein the freight to be loaded comprises one or more containers.

3. The device in accordance with claim 1, wherein the predefined contour comprises an upper side of a piece of freight.

4. The device in accordance with claim 1, wherein a first predefined contour comprises an upper side of a single container.

5. The device in accordance with claim 1, wherein a second predefined contour comprises an upper side of two containers arranged behind one another.

6. The device in accordance with claim 1, wherein a first predefined contour comprises an upper side of a 40 foot container.

7. The device in accordance with claim 1, wherein a second predefined contour comprises an upper side of a 20 foot container.

8. The device in accordance with claim 1, wherein a third predefined contour comprises an upper side of two 20 foot containers arranged behind one another.

9. The device in accordance with claim 1, wherein the sensor is configured as a 2D LiDAR sensor.

10. The device in accordance with claim 1, wherein the sensor is configured as a 3D LiDAR sensor.

11. The device in accordance with claim 1, wherein the sensor is attached to a spreader of a crane that is provided to take up the freight.

12. The device in accordance with claim 11, wherein the signal comprises information to adjust the spreader and the output unit is configured to output the signal to an operator and/or to a control of the crane.

13. The device in accordance with claim 11, wherein the evaluation unit is configured to determine a distance of the freight from the spreader from the set of spatial coordinates of the measurement points and the output unit is configured to output the distance to an operator and/or to a control of the crane.

14. The device in accordance with claim 11, wherein the evaluation unit is configured to determine a longitudinal offset of the freight from the spreader from the set of spatial coordinates of the measurement points and the output unit is configured to output the longitudinal offset to an operator and/or to a control of the crane.

15. The device in accordance with claim 11, wherein the evaluation unit is configured to determine an angle between the upper side of the freight and a lifting direction in which the freight is raised by the crane from the set of spatial coordinates of the measurement points and the output unit is configured to output the determined angle to an operator and/or to a control of the crane.

16. A method of monitoring freight to be loaded, said method comprising the following steps:
detecting at least one set of spatial coordinates of measurement points by means of a sensor, wherein the measurement points lie in a spatial zone that comprises the freight;
determining at least a part of a contour of the freight from the set of spatial coordinates of the measurement points;
comparing the determined contour of the freight with at least one predefined contour; and
outputting a signal based on a result of the comparison.

17. The method in accordance with claim 16, wherein the freight to be loaded comprises one or more containers.

18. The method in accordance with claim 16, wherein the predefined contour comprises an upper side of a piece of freight.

19. The method in accordance with claim 16, wherein a first predefined contour comprises an upper side of a single container and/or a second predefined contour comprises an upper side of two containers arranged behind one another.

20. The method in accordance with claim 16, wherein a first predefined contour comprises an upper side of a 40 foot container, and/or a second predefined contour comprises an upper side of a 20 foot container, and/or a third predefined contour comprises an upper side of two 20 foot containers arranged behind one another.
